(19) United States
(12) Patent Application Publication
(10) Pub. No.: US 2024/0239142 A1
(43) Pub. Date: Jul. 18, 2024

(54) DOOR-TRIGGERED TIRE PRESSURE DETECTION SYSTEM AND METHOD FOR WAKING UP THE SAME

(71) Applicant: SHIH-YAO LIN, TAIPEI CITY (TW)

(72) Inventor: SHIH-YAO LIN, TAIPEI CITY (TW)

(21) Appl. No.: 18/411,036

(22) Filed: Jan. 12, 2024

(30) Foreign Application Priority Data
Jan. 18, 2023 (TW) 112102356

(51) Int. Cl. B60C 23/00; B60C 23/04; G01L 17/00

(52) U.S. Cl. CPC B60C 23/002; B60C 23/0438; G01L 17/00

(57) ABSTRACT

A car door-triggered tire pressure detection system includes an on-board unit with an ECU unit connected to a main high-frequency transceiver module, a main display, and a door sensing module. The on-board unit does not include a vehicle low- frequency circuit and a vehicle low-frequency antenna. Multiple TPMS each include a TPMS main control unit connected to a TPMS high-frequency transceiver module. Each TPMS does not include a TPMS low-frequency circuit and a TPMS low-frequency antenna. When the door sensing module detects a car door is opened, the main display shows the tire pressure values returned by each TPMS. The problem of excessive antennas used in known wireless transmission systems is improved. When the door sensing module detects the opening of the car door, the main display shows the tire pressure values returned by each TPMS.

### FIELD OF THE INVENTION

The present invention relates to a car door-triggered tire pressure detection system and a wake-up method of the tire pressure detection system, combining a door sensing module and high-frequency wireless technology. This system can awaken the

TPMS (Tire Pressure Monitoring System) of the vehicle and display data of tire pressure when the car door is opened without the need to move the vehicle.

### BACKGROUND OF THE INVENTION

A Tire pressure is a crucial value for determining the safety of a vehicle, and with the advancement of technology, the methods for detecting tire pressure have progressed significantly. From the manual measurement of each wheel in the past, we now have various electronic devices that automatically measure and transmit data to a monitoring screen, making the process much more convenient.

Typically, a complete tire pressure detection system requires at least one tire pressure sensor for each wheel, and the main system of the vehicle needs to be equipped with an on-board unit for monitoring data. As the wheels of a vehicle rotate at high speeds during motion, a wired transmission between the tire pressure sensors and the on-board unit is not suitable. Therefore, wireless transmission is preferred. For example, as shown in FIGS. 4 and 5, each TPMS (Tire Pressure Monitoring System) 200 needs to have a matching LF device 300 (LF: Low frequency). The on-board unit 100 for monitoring data and TPMS 200 are equipped with high-frequency antennas, low-frequency antennas, high-frequency circuits, and low-frequency circuits. In operation, the low-frequency antenna emits a signal through the LF device 300 to trigger TPMS 200. Once awakened, TPMS 200 immediately reads voltage, temperature, pressure, and other data, responding with this data using the high-frequency circuit and high-frequency antenna.

However, those known tire pressure detection systems suffer from the use of multiple types of antennas. For instance, a single TPMS may have one high-frequency antenna and one low-frequency antenna. With four wheels, this results in a total of eight antennas, placing a considerable burden on signal transmission and increasing costs.

Additionally, in traditional vehicles, the setup for transmitting tire pressure information often involves TPMS sending out data for the first time only after the vehicle has started moving. Therefore, if there is an abnormal tire pressure, the driver may not be aware until the vehicle is in motion. However, due to insufficient tire pressure in the tires before the vehicle starts moving, the rolling wheels can lead to ineffective protection of the wheel rims, resulting in damage and deformation. The present invention intends to provide a car door-triggered tire pressure detection system and a wake-up method of the tire pressure detection system to eliminate the shortcomings mentioned above.

### SUMMARY OF THE INVENTION

The present invention relates to a car door-triggered tire pressure detection system and comprises an on-board unit which includes an ECU unit electrically connected to a main high-frequency transceiver module, a main display, and a door sensing module. The on-board unit excludes a vehicle low-frequency circuit and a vehicle low-frequency antenna. Multiple TPMS each include a TPMS main control unit electrically connected to a TPMS high-frequency transceiver module. Each TPMS high-frequency transceiver module matches with the main high-frequency transceiver module through high-frequency wireless signals. Each TPMS excludes a TPMS low-frequency circuit and a TPMS low-frequency antenna. When the door sensing module detects an opening of a car door, the main display displays tire pressure values returned by each TPMS.

Alternatively, the present invention also provides a wake-up method for a car door-triggered tire pressure detection system, and the method comprises the following steps: when a car door is opened, a door sensing module of an on-board unit detects the opening of the car door, an ECU unit of the on-board unit commands a main high-frequency transceiver module to wirelessly wake up the matched TPMS using high-frequency signals. When each TPMS unit is waken up, and the TPMS main control unit processes a detected data, transmitting wireless high-frequency signals back to the main high-frequency transceiver module via a TPMS high-frequency transceiver module. The on-board unit receives the signals returned by each TPMS and displays the detected data on a main display.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the schematic diagram of the car door-triggered tire pressure detection system of the present invention;

FIG. 2 illustrates actual application of the car door-triggered tire pressure detection system of the present invention;

FIG. 3 illustrates a scenario diagram of abnormal tire pressure during the actual application of the present invention; FIG. 4 illustrates a conventional tire pressure monitoring system, and

FIG. 5 illustrates the data transmission architecture between the conventional on-board unit and TPMS.

### DETAILED DESCRIPTION OF THE PREFERRED EMBODIMENT

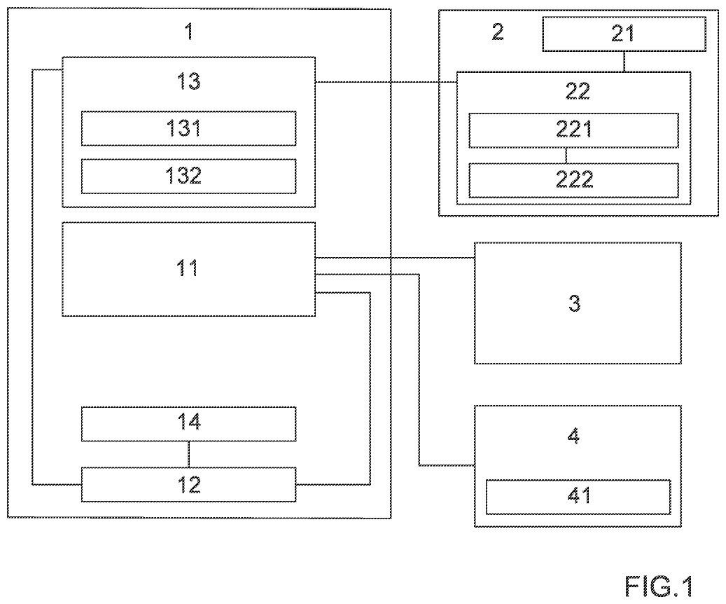

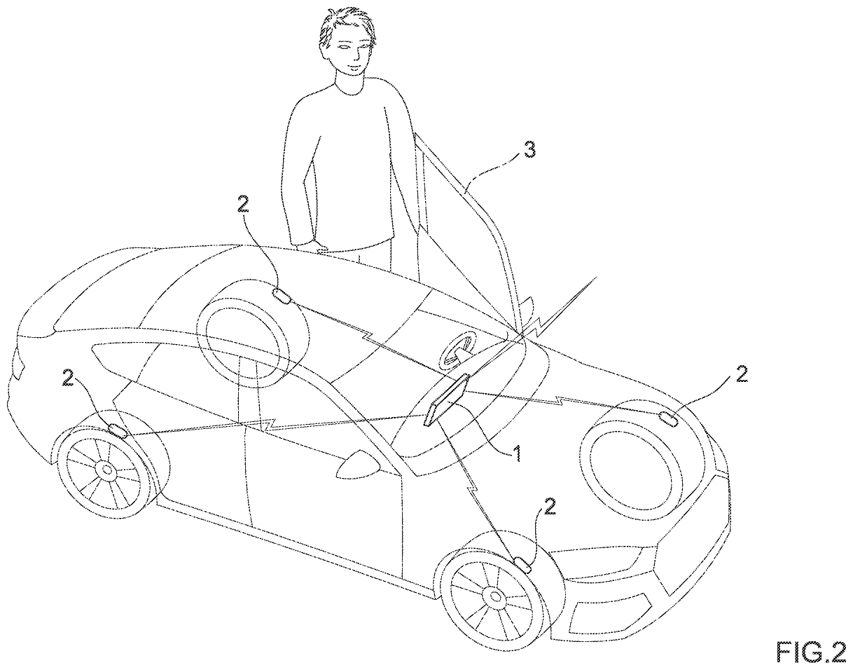

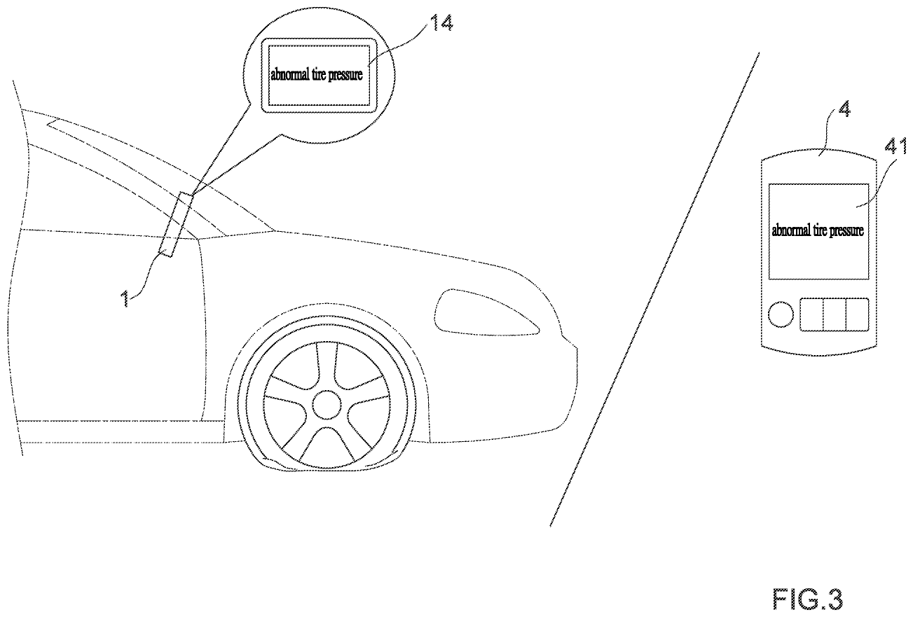

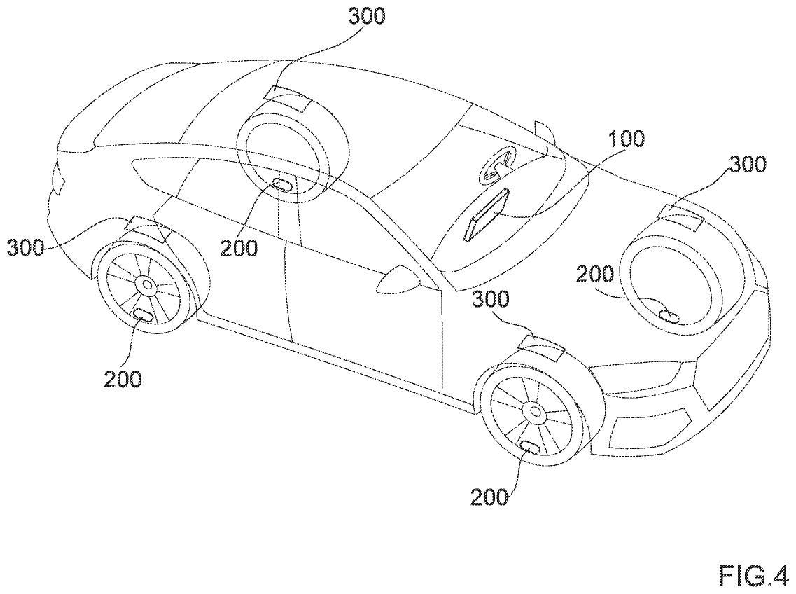

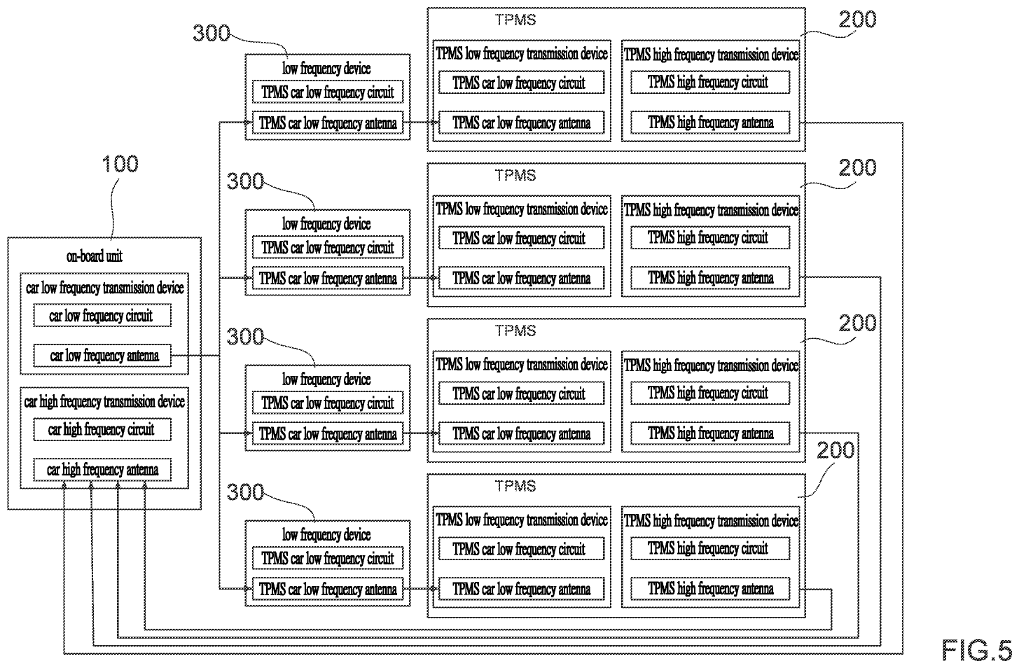

Referring to FIGS. 1 and 2, the car door-triggered tire pressure detection system comprises an on-board unit(1) which includes an ECU unit (12) (electronic control unit) electrically connected to a main high-frequency transceiver module (13), a main display (14), and a door sensing module (11). The on-board unit (1) excludes a vehicle low-frequency circuit and a vehicle low-frequency antenna. Multiple TPMS (2) (tire pressure monitoring system) each include a TPMS main control unit (21) electrically connected to a TPMS high-frequency transceiver module (22). Each TPMS high-frequency transceiver module (22) matches with the main high-frequency transceiver module (13) through high-frequency wireless signals. Each TPMS (2) excludes a TPMS low-frequency circuit and a TPMS low-frequency antenna. When the door sensing module (11) detects an opening of a car door (3), the main display (14) displays tire pressure values returned by each TPMS (2). As shown in FIG. 3, the main high-frequency transceiver module (13) matches with a car key (4) using high-frequency signals. The car key (4) includes a car key display (41). When the main display (14) displays the tire pressure values returned by each TPMS (2), the car key display (41) synchronously displays the same tire pressure values.

Preferably, the signal transmission methods of the main high-frequency transceiver module (13) and the TPMS high-frequency transceiver module (22) are BLE (Bluetooth low energy), OOK (on-off keying), RFID (radio frequency identification), WI-FI, UWB (ultra-wideband), Zigbee (zonal intercommunication global standard), LPWAN (low-power wide-area network).

The low frequency is less than or equal to 150 KHz.

The door sensing module (11) can be a build-in system used to determine whether the car door (3) is securely closed, or an additionally configured infrared detection system. It can also be combined with other door-opening systems to detect whether the car door (3) is open. The methods of opening the car door (3) may include manual opening, magnetic card sensing, remote control, and other methods.

The main high-frequency transceiver module (13) comprises a main high-frequency antenna (131) and a main high-frequency RF unit (132). The TPMS high-frequency transceiver module (22) comprises a TPMS high-frequency antenna (221) and a TPMS high-frequency RF unit (222).

A wake-up method for a car door-triggered tire pressure detection system of the present invention comprises the following steps: when a car door (3) is opened, a door sensing module (11) of an on-board unit (1) detects the opening of the car door (3). An ECU unit (12) of the on-board unit (1) commands a main high-frequency transceiver module (13) to wirelessly wake up the matched TPMS (2) using high-frequency signals. When each TPMS unit (2) is waken up, and the TPMS main control unit (21) processes a detected data, transmitting wireless high-frequency signals back to the main high-frequency transceiver module (13) via a TPMS high-frequency transceiver module (22). The on-board unit (1) receives the signals returned by each TPMS (2) and displays the detected data on a main display (14).

The vehicle on-board unit (1) and TPMS (2) are equipped with the main high-frequency transceiver module (13) and the TPMS high-frequency transceiver module (22), and neither uses low-frequency circuits nor low-frequency antennas. The signal transmission between the components is done using only high-frequency signals. In comparison, the present invention indeed improves the configuration of those conventional wireless transmission systems for vehicles, addressing the issue of excessive antenna types. In the present invention, the vehicle on-board unit (1) saves a set of low-frequency antennas and circuits, and TPMS (2) typically requires four sets. In other words, the present invention saves four sets of low-frequency antennas and circuits. In other words, the present invention saves at least five sets of low-frequency antennas and circuits compared to known products, reducing production and installation costs related to low-frequency antennas and circuits. As shown in FIG. 3, the present invention, in conjunction with the car door sensing module (11) and the TPMS (2), allows the vehicle to obtain abnormal tire pressure values without the need to start or move the vehicle. This overcomes the issue in many conventional technologies where the vehicle must move before sending out tire pressure values. Discovering abnormal tire pressure values only after the vehicle has moved can be dangerous. As depicted in FIG. 3, if the tire pressure of tires is insufficient or damaged before the vehicle moves, the wheel rims can lead to ineffective wheel rims protection, resulting in damage and deformation of the wheel rims. Therefore, the capability to obtain abnormal tire pressure values without starting or moving the vehicle is highly necessary.

While we have shown and described the embodiment in accordance with the present invention, it should be clear to those skilled in the art that further embodiments may be made without departing from the scope of the present invention.

What is claimed is:

1. A car door-triggered tire pressure detection system comprising:
an on-board unit (1) including an ECU unit (12) electrically connected to a main high-frequency transceiver module (13), a main display (14), and a door sensing module (11), the on-board unit (1) excluding a vehicle low-frequency circuit and a vehicle low-frequency antenna, and
multiple TPMS (2) each including a TPMS main control unit (21) electrically connected to a TPMS high-frequency transceiver module (22), each TPMS high-frequency transceiver module (22) matching with the main high-frequency transceiver module (13) through high-frequency wireless signals, each TPMS (2) excluding a TPMS low-frequency circuit and a TPMS low-frequency antenna, when the door sensing module (11) detects an opening of a car door (3), the main display (14) displays tire pressure values returned by each TPMS (2).

2. The car door-triggered tire pressure detection system as claimed in claim 1, wherein signal transmission methods of the main high-frequency transceiver module (13) and the TPMS high-frequency transceiver module (22) are BLE (Bluetooth low energy), OOK (on-off keying), RFID (radio frequency identification), WI-FI, UWB (ultra-wideband), Zigbee (zonal intercommunication global standard), LPWAN (low-power wide-area network).

3. The car door-triggered tire pressure detection system as claimed in claim 1, wherein the main high-frequency transceiver module (13) comprises a main high-frequency antenna (131) and a main high-frequency RF unit (132), the TPMS high-frequency transceiver module (22) comprises a TPMS high-frequency antenna (221) and a TPMS high-frequency RF unit (222).

4. The car door-triggered tire pressure detection system as claimed in claim 1, wherein the main high-frequency transceiver module (13) matches with a car key (4) using high-frequency signals, the car key (4) includes a car key display (41), when the main display (14) displays the tire pressure values returned by each TPMS (2), the car key display (41) synchronously displays the same tire pressure values.

5. A wake-up method for a car door-triggered tire pressure detection system, comprising the following steps: when a car door (3) is opened, a door sensing module (11) of an on-board unit (1) detects the opening of the car door (3), an ECU unit (12) of the on-board unit (1) commands a main high-frequency transceiver module (13) to wirelessly wake up the matched TPMS (2) using high-frequency signals, when each TPMS unit (2) is waken up, and the TPMS main control unit (21) processes a detected data, transmitting wireless high-frequency signals back to the main high-frequency transceiver module (13) via a TPMS high-frequency transceiver module (22), the on-board unit (1) receives the signals returned by each TPMS (2) and displays the detected data on a main display (14).

6. The wake-up method for the car door-triggered tire pressure detection system as claimed in claim 5, wherein signal transmission methods of the main high-frequency transceiver module (13) and the TPMS high-frequency transceiver module (22) are BLE (Bluetooth low energy), OOK (on-off keying), RFID (radio frequency identification), WI-FI, UWB (ultra-wideband), Zigbee (zonal intercommunication global standard), LPWAN (low-power wide-area network).

7. The wake-up method for the car door-triggered tire pressure detection system as claimed in claim 5, wherein the main high-frequency transceiver module (13) comprises a main high-frequency antenna (131) and a main high-frequency RF unit (132), the TPMS high-frequency transceiver module (22) comprises a TPMS high-frequency antenna (221) and a TPMS high-frequency RF unit (222).

8. The wake-up method for the car door-triggered tire pressure detection system as claimed in claim 5, wherein the main high-frequency transceiver module (13) matches with a car key (4) using high-frequency signals, the car key (4) includes a car key display (41), when the main display (14) displays the tire pressure values returned by each TPMS (2), the car key display (41) synchronously displays the same tire pressure values.
